(19) United States
(12) Patent Application Publication
(10) Pub. No.: US 2010/0061766 A1
(43) Pub. Date: Mar. 11, 2010

(54) IMAGE FORMING APPARATUS

(75) Inventors: Jeong-yeon PARK, Hwaseong-si (KR); Byung-sun AHN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/492,508

(22) Filed: Jun. 26, 2009

(30) Foreign Application Priority Data
Sep. 9, 2008 (KR) 2008-88812

(51) Int. Cl. G03G 15/01

(52) U.S. Cl. 399/223

(57) ABSTRACT

An image forming apparatus can include a first developing portion having first to fourth developing devices containing yellow, magenta, cyan, and black developers, respectively, each of the first to fourth developing devices being disposed apart from adjacent developing devices of the first to fourth developing devices at a regular interval, a second developing portion to include at least one auxiliary developing device to supplement colors of the first developing portion, and an image carrier to convey images of the first and second developing portions, wherein an interval between the first and second developing portions is a multiple of the regular interval between the first to fourth developing devices.

### CROSS-REFERENCE TO RELATED APPLICATIONS

This application claims priority under 35 U.S.C. § 119(a) from Korean Patent Application No. 2008-0088812, filed on Sep. 9, 2008, in the Korean Intellectual Property Office, the contents of which are incorporated herein by reference in its entirety.

### BACKGROUND

1. Field of the Inventive Concept

The present general inventive concept relates to an image forming apparatus, and more particularly, to an image forming apparatus having developing units of four or more colors

2. Description of the Related Art

General electrophotographic image forming apparatuses use a color developing unit which contains four developers including cyan, magenta, yellow, and black in order to form a color image. Such image forming apparatuses using a dry developer are suitable for printing data at high speed and offer advantages for maintenance and repair.

If a color image requires high resolution, for example, if a photo is printed, the high resolution color image may contain color areas which cannot be represented using these four developers.

An electrophotographic image forming apparatus using a digital image signal forms an electrostatic latent image by adjusting the density of dots having a predetermined voltage. However, it is difficult for the electrophotographic image forming apparatus to transfer developer particles uniformly to dots having the predetermined voltage. The gradation of an image, which corresponds to the ratio of dot density of areas to which developer is attached to that of areas to which developer is not attached uniformly. Even if the resolution is enhanced by forming dots having a small size, there are limitations to the reproducibility, gray level, and sharpness of an image.

On part of an image on which light color such as light yellow, light red, or light blue is printed, the electrophotographic image forming apparatus reduces the number of dots in order to represent a light color. Accordingly, color reproducibility is reduced, and clarity may be diminished due to the reduction in the number of dots.

### SUMMARY

The present general inventive concept provides an image forming apparatus in which color reproducibility and color registration of a printed image are enhanced.

The present general inventive concept also provides an image forming apparatus in which the arrangement of color developing devices are improved so that the image forming apparatus is miniaturized.

Additional utilities of the present general inventive concept will be set forth in part in the description which follows and, in part, will be obvious from the description, or may be learned by practice of the general inventive concept.

An example embodiment of the present general inventive concept may be achieved by providing a an image forming apparatus, including a first developing portion having first to fourth developing devices containing yellow, magenta, cyan, and black developers, respectively, each of the first to fourth developing devices disposed apart from adjacent developing devices of the first to fourth developing devices at a regular interval, a second developing portion having at least one auxiliary developing device to supplement colors of the first developing portion, and an image carrier to convey images of the first and second developing portions, wherein an interval between the first and second developing portions is a multiple of the regular interval D1 between the first to fourth developing devices.

The multiple can be an integer greater than 1.

The first and second developing portions may be disposed on opposite sides of the image carrier.

The image carrier may be a belt rotating in an endless track, wherein the image carrier may be one of an intermediate transferring unit and a paper feeding and transfer unit.

The image forming apparatus may further include a laser scanning unit to form an electrostatic latent image on the first and second developing portions, wherein the laser scanning unit comprises a first laser scanning unit to form an electrostatic latent image on the first developing portion, and a second laser scanning unit to form an electrostatic latent image on the second developing portion.

The image carrier may include an intermediate transferring belt, a first driving roller disposed between the first and second developing portions, a second driving roller disposed to correspond to a transferring roller to transfer a color image on the printing medium, and a tension roller disposed between the first and second driving rollers, to adjust the tension of the intermediate transferring belt.

A speed of the second driving roller may be set to be about 0 to 3% faster than a speed of the first driving roller, and the speed of the second driving roller may be set to be about 1% faster than a speed of the first driving roller.

The first developing portion may transfer yellow, magenta, cyan, and black developer on a printing image after the second developing portion transfers the printing image to the image carrier.

The second developing portion may include a first auxiliary developing device to use a light cyan developer, and a second auxiliary developing device to print a light magenta developer, wherein the second developing portion may include an auxiliary developing device to use one of developers having transparent and white colors, and the second developing portion may include a first auxiliary developing device to use a developer having a light cyan color; a second auxiliary developing device to use a developer having a light magenta color, and a third auxiliary developing device to use one of developer having transparent and white colors.

Exemplary embodiments of the present general inventive concept may also be achieved by providing an image forming apparatus, including a first developing portion having first and second developing devices at a regular interval, and a second developing portion having a third developing device disposed closer to the first developing device than the second developing device, wherein the first and second developing portions convey an image to an image carrier, and if an interval between the first and second developing devices on the image carrier is, an interval between the first and third developing devices is a multiple of the regular interval.

The color of an image formed by the first to third developing devices may differ from each other.

The image forming apparatus may selectively use a first printing mode in which an image is formed using the first developing portion, and a second printing mode in which an image is formed using both the first and second developing portions, wherein the first and second printing modes may be selected by a user using the image forming apparatus or a peripheral connected to the image forming apparatus over wire or wirelessly.

The image carrier may be a belt rotating in an endless track, wherein the image carrier may be one of an intermediate transferring unit or a paper feeding and transfer unit.

The first and second developing devices of the first developing portion may selectively use yellow, magenta, cyan, and black developers, and the third developing device of the second developing portion may selectively use light magenta, light cyan, white, and transparent developers.

Exemplary embodiments of the present general inventive concept may also be achieved by providing a developing unit of an image forming apparatus, the developing unit including a developing portion having a plurality of developing devices disposed at regular intervals along an image carrier to develop images on the image carrier, and at least one auxiliary developing device spaced apart from the developing portion at an interval different from the regular interval to supplement the images on the image carrier.

The developing unit may further include a user interface to selectively control parameters of a first printing mode in which an image is formed using the developing portion and a second printing mode in which an image is formed using both the developing portion and the at least one auxiliary developing device.

The user interface may be connected to the image forming apparatus via a wired or wireless network.

The at least one auxiliary developing device may be disposed on an image transfer plane opposed to an image transfer plane of the developing portion.

The at least one auxiliary developing device may be disposed on an image transfer plane of the developing portion.

The interval can be a multiple n of the regular interval, where n is a number greater than or equal to 1.

The multiple n may be a number less than 1.

### BRIEF DESCRIPTION OF THE DRAWINGS

Exemplary embodiments of the present general inventive concept will become apparent and more readily appreciated from the following description of the embodiments, taken in conjunction with the accompanying drawings of which:

FIG. 1 is a schematic view illustrating an image forming apparatus according to an exemplary embodiment of the present general inventive concept;

FIG. 2 is a schematic view illustrating an image forming apparatus according to a another exemplary embodiment of the present general inventive concept;

FIG. 3 is a schematic view illustrating an image forming apparatus according to another exemplary embodiment of the present general inventive concept;

FIG. 4 is a schematic view illustrating an image forming apparatus according to another exemplary embodiment of the present general inventive concept; and

FIG. 5 is a block diagram illustrating an image forming apparatus according to another exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

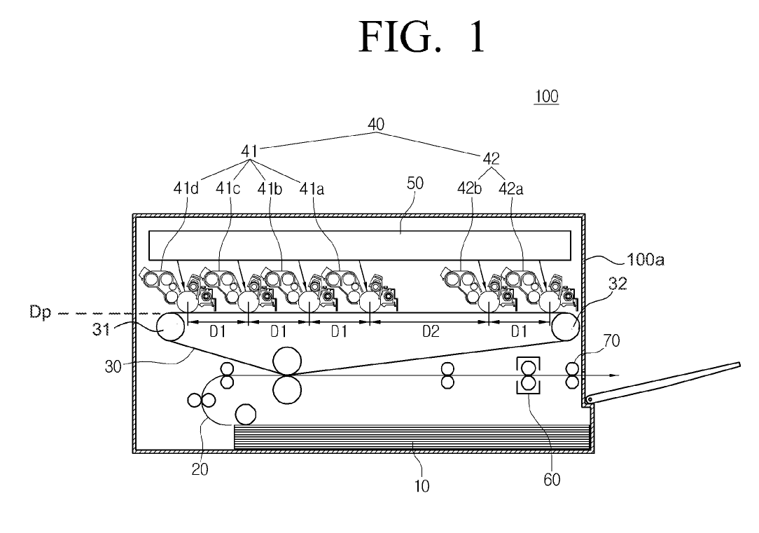

FIG. 1 is a schematic view illustrating an image forming apparatus according to an exemplary embodiment of the present general inventive concept.

Referring to FIG. 1, an image forming apparatus 100 according to an exemplary embodiment of the present general inventive concept can include a paper pick up unit 10, a feeding unit 20, an image carrier 30, a developing unit 40, a laser scanning unit 50, a fixing unit 60, a discharging unit 70, a first driving roller 31, a second driving roller 32, and a housing 100a to house elements of the image forming apparatus 100.

The pick up unit 10 can house a plurality of printing media, and the printing media can be supplied to the image carrier 30 and the developing unit 40 through the feeding unit 20. A printing medium supplied through the feeding unit 20 can receive a color image transferred to the image carrier 30, and the image can be fixed on the printing medium by heat and pressure while the printing medium passes through the fixing unit 60. When the color image has been printed on the printing medium by the above operations, the printing medium can be discharged to the outside of the image forming apparatus 100 by the discharging unit 70.

The developing unit 40 can include first and second developing portions 41 and 42.

The first developing portion 41 can include first to fourth developing devices 41a to 41d containing yellow, magenta, cyan, and black developers, respectively. Each of the first to fourth developing devices can be disposed apart from adjacent developing devices of the first to fourth developing devices at a regular interval D1.

The second developing portion 42 can be provided to represent colors which the first developing portion 41 cannot represent or has a difficulty representing. As illustrated in FIG. 1, a first auxiliary developing device 42a to print a light cyan color and a second auxiliary developing device 42b to print a light magenta color can be provided. However, it is possible that the first and second auxiliary developing devices may also print transparent and white colors as occasion demands, without departing from the principals and spirit of the present general inventive concept.

The first developing portion 41 may be disposed apart from the second developing portion 42 at a predetermined interval D2 as illustrated in FIG. 1. Interval D2 may be a multiple of interval D1 (n×D1) between the first to fourth developing devices 41a to 41d constituting the first developing portion 41. Herein, n may be a positive integer, and if the first and second developing portions 41 and 42 are disposed on the same surface of the image carrier 30 as illustrated in FIG. 1, n may be 1. However, the present general inventive concept is not limited thereto. For example, n may be a number other than a positive integer.

Referring to FIG. 1, the image carrier 30 can define an image transfer plane Dp to receive images formed by the developing unit 40. For example, as illustrated in FIG. 1, the image transfer plane Dp can be formed on an upper surface of the image carrier 30 between the first driving roller 31 and the second driving roller 32 such that the first developing portion 41 and the second developing portion 42 are disposed on the same side of the image carrier 30 to face the image transfer plane Dp.

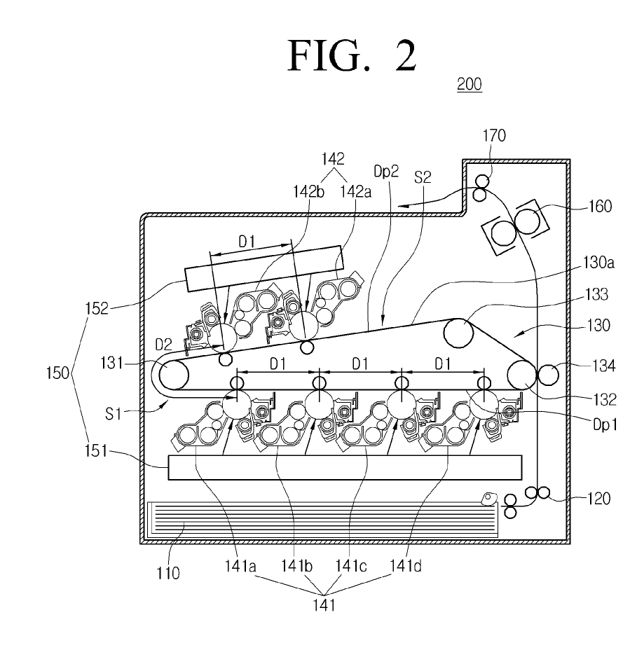

FIG. 2 is a schematic view illustrating an electrophotographic image forming apparatus having developing devices of six colors according to another exemplary embodiment of the present general inventive concept.

Referring to FIG. 2, an electrophotographic image forming apparatus 200 having developing devices of six colors can include a pick up unit 110, a feeding unit 120, an image carrier 130, a developing unit 140, a laser scanning unit 150, a fixing unit 160, and a discharging unit 170.

The pick up unit 110, the feeding unit 120, the fixing unit 160, and the discharging unit 170 can be the same as those of the exemplary embodiment of FIG. 1, and thus a description thereof will be omitted.

The image carrier 130 may be formed as a belt rotating in an endless track, and may be an intermediate transfer unit or a paper feeding and transfer unit. Hereinbelow, an image carrier 130 formed as an intermediate transfer unit will be explained as an example.

The image carrier 130 can include an intermediate transfer belt 130a, a first driving roller 131, a second driving roller 132, a tension roller 133, and a transfer roller 134. The transfer roller 134 can be mounted on part of the image carrier 130 facing the second driving roller 132.

The speed V2 of the second driving roller 132 may be set to be about 0 to 3% faster than the speed V1 of the first driving roller 131. According to an exemplary embodiment of the present general inventive concept, the speed V2 of the second driving roller 132 may be set to be about 1% faster than the speed V1 of the first driving roller 131. For example, since the transfer belt 130a of FIG. 2 can move in a counter clockwise direction, if the speed V2 of the second driving roller 132 is set to be faster than the speed V1 of the first driving roller 131, part of the transfer belt rotated by the first driving roller 131 disposed on a lower portion of the image carrier 130 can be longer than part of the transfer belt rotated by the second driving roller 132 disposed at an upper portion of image carrier 130. Accordingly, one of the causes of image quality degradation such as belt trembling can be reduced.

However, if the first and second driving rollers are set to be driven at the same speed, part of the transfer belt moving toward the lower portion can be longer than part of the transfer belt moving from the upper portion even if the first to fourth developing devices 141a to 141d constituting the first developing portion 141 disposed between the first and second driving rollers 131 and 132 are disposed apart at regular intervals D1. As a result, the intervals D1 between the first to fourth developing devices 141a to 141d with respect to the transfer belt 130a can be different. Such different intervals of the transfer belt 130a can cause an image not to be printed correctly on the printing medium. Therefore, it is possible that the speed V1 of the first driving roller 131 can be set faster than the speed V2 of the second driving roller 132 to improve the quality of the image formed on and conveyed by the transfer belt 130a.

If the image carrier 130 is provided as a paper feeding and transfer unit (not illustrated), a printing medium can be conveyed through the paper feeding and transfer unit, and the developer contained in the developing unit 140 can be placed on the printing medium. Accordingly, a printing image may be formed on the printing medium. Since the structure of the paper feeding and transfer unit is well known, description thereof will be omitted.

The developing unit 140 can include the first and second developing portions 141 and 142.

The first developing portion 141 can include the first to fourth developing devices 141a to 141d containing yellow, magenta, cyan, and black developers, respectively. Each of the first to fourth developing devices can be disposed apart from adjacent developing devices of the first to fourth developing devices at a regular interval D1, and can transfer a color image to the intermediate transfer belt 130a.

The second developing portion 142 can be provided to represent colors which the first developing portion 141 cannot represent or has difficulty representing. The first and second developing portions 141 and 142 can be disposed on opposite sides of the image carrier 130 as illustrated in FIG. 2. If part of the intermediate transfer belt 130a contacting to the first developing portion 141 is referred to as a first surface S1 and part of the intermediate transfer belt 130a contacting to the second developing portion 142 is referred to as a second surface S2, the first surface S1 may be a surface different from the second surface S2. In this situation, the first and second developing portions 141 and 142 can be disposed on an upper portion and a lower portion of the developing unit 140, respectively. Accordingly, the volume of the developing unit 140 can be reduced.

For example, referring to FIG. 2, the image carrier 130 can define a first image transfer plane Dp1 and a second image transfer plane Dp2 disposed on opposing sides of the image carrier 130 to receive images formed by the first developing portion 141 and the second developing portion 142, respectively. As illustrated in FIG. 2, the first image transfer plane Dp1 can be formed on a lower surface of the image carrier 130 between the first driving roller 131 and the second driving roller 132, and the second image transfer plane Dp2 can be formed on an upper surface of the image carrier 130 between the first driving roller 31 and the tension roller 133. The first image transfer plane Dp1 and the second image transfer plane Dp2 can be formed at an angle with respect to each other as illustrated in FIG. 2. However, the present general inventive concept is not limited thereto, and it is possible that the first and second image transfer planes Dp1, Dp2 can be formed perpendicular to each other or parallel to each other, without departing from the principles and spirit of the present general inventive concept.

As illustrated in FIG. 2, the second developing portion 142 may include a first auxiliary developing device 142a to print a light cyan color and a second auxiliary developing device 142b to print a light magenta color. When a color image is formed using only four colors such as yellow, magenta, cyan, and black, the number of dots corresponding to a light color can be decreased in order to represent the light color, so a color image requiring high resolution such as a photo can be printed with low color reproducibility. However, if auxiliary developing devices are 142a, 142b added to represent light colors such as light cyan and light magenta as illustrated in FIG. 2, color reproducibility can be enhanced.

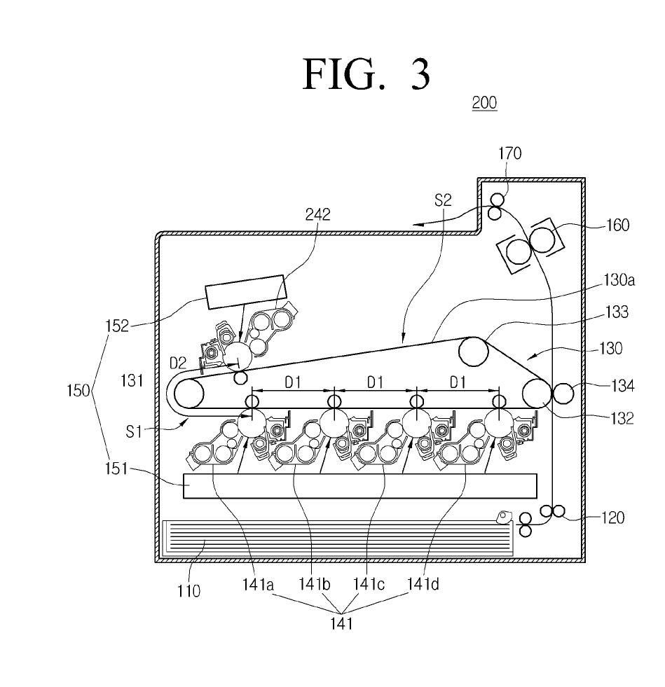

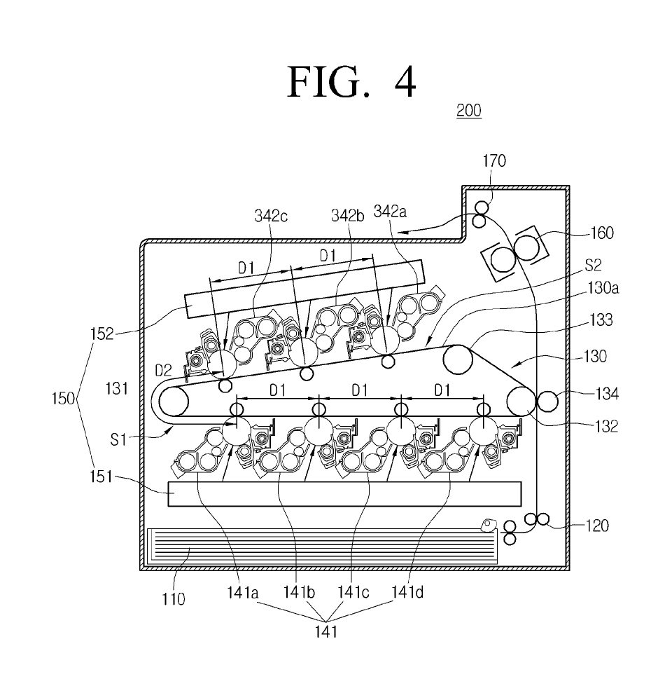

Alternatively, the second developing portion 142 may include one auxiliary developing device 242 to print transparent colors as illustrated in FIG. 3 so that a coating effect can be created on a printing medium on which a color image is formed, or the second developing portion 142 may include first to third auxiliary developing devices 342a to 342c as illustrated in FIG. 4 in order to print light colors such as light cyan and light magenta and to print white, which can be used to correct contamination on an image or preserve a secret document.

If the second developing portion 142 includes two or more auxiliary developing devices as illustrated in FIGS. 2 and 4, the interval between the auxiliary developing devices may be the same as the interval D1 between the first to fourth developing devices 141a to 141d. However, the auxiliary developing devices may be disposed so that the interval is a multiple of interval D1 (n×D1) as occasion demands, where n is a number greater than, less than, or equal to 1.

The first and second developing portions 141 and 142 can be disposed apart at a predetermined interval D2 with the first driving roller 131 in between. The interval D2 may be a multiple of the interval D1 (n×D1) between the first to fourth developing devices 141a to 141d constituting the first developing portion 141. Herein, n may be a positive integer, and if the first and second developing portions 141 and 142 are disposed on the opposite sides with the image carrier 30 in between, n may be 4.

If the first and second developing portions 141 and 142 are disposed on opposite sides of the image carrier 130 as illustrated in FIGS. 2 and 4, the laser scanning unit 150 can include first and second laser scanning units 151 and 152. The first laser scanning unit 151 can form an electrostatic latent image on the first developing portion 141, and the second laser scanning unit 152 can form an electrostatic latent image on the second developing portion 142. The first laser scanning unit 151 may be disposed between the pick up unit 110 and the first developing portion 141, and the second laser scanning unit 152 may be disposed on an upper portion of the second developing portion 142.

The operations of the image forming apparatus 100 according to an exemplary embodiment of the present general inventive concept will be explained with reference to FIG. 2.

When a printing operation is started, a printing medium housed in the pick up unit 110 can be picked up and conveyed to the image carrier 130 and the developing unit 140 by the feeding unit 120. In this case, an electrostatic latent image can be formed on the first and second developing portions 141 and 142 of the developing unit 140 according to each color information, and a printing image can be transferred to the image carrier 130.

In the transferring operation, the first developing portion 141 may first transfer a color image and then the second developing portion 142 may transfer a color image, or the second developing portion 142 may first transfer a color image to the image carrier 130 and then the first developing portion 141 may transfer a color image.

If a user desires to form an image having light cyan and light magenta using the second developing portion in order to print at optimum speed, the second developing portion 142 can transfer an image, and the first developing portion 141 can form yellow, magenta, cyan, and black colors on the image transferred by the second developing portion 142 and can transfer the image.

If the first and second developing portions 141 and 142 are disposed to be opposite each other with respect to the intermediate transfer belt 130a as illustrated in FIGS. 2 and 4, it is difficult to dispose the developing devices and the auxiliary developing devices constituting the first and second developing portions 141 and 142 at the same intervals. As illustrated in FIG. 2, if the interval between the developing devices containing yellow, magenta, cyan, and black developers is referred to as interval D1, interval D2 between the first and second developing portions 141 and 142 can be set to be a multiple of interval D1 (n×D1). If the interval D2 is set to be a multiple of interval D1, the transferring operation may be controlled more accurately by a specific controlling unit. Accordingly, an image can be prevented from being transferred to an incorrect location and therefore being contaminated.

If the speed V2 of the second driving roller 132 disposed to correspond to the transfer roller 134 is set to be about 1% faster than the speed V1 of the first driving roller 131 disposed between the first and second developing portions 141 and 142 to rotate the intermediate transfer belt 130a, errors caused by the rotation of the intermediate transfer belt 130a may be minimized.

The first developing portion 141 may include first and second developing devices and the second developing portion 142 may include first to third developing devices (not illustrated). The first and second developing devices may contain two colors among yellow, magenta, cyan, and black, and the third developing device may contain one of light cyan, light magenta, white, and transparent colors.

A user may select a printing mode according to the type of data to be printed or the amount of toner remaining. For example, if a user desires to print an image using colors provided only by the first developing portion 141, the user may select a first printing mode in which yellow, magenta, cyan, and black are used, and if a user desires to print an image using other colors, the user may select a second printing mode in which the second developing portion 142 containing white, light cyan, light magenta, and transparent colors is used.

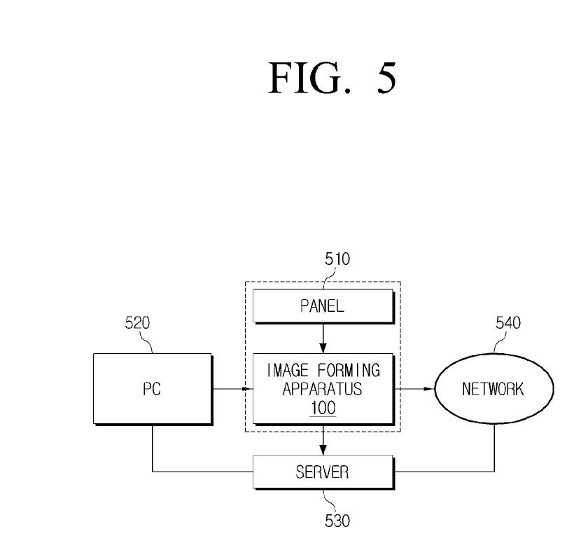

For example, FIG. 5 is a block diagram illustrating an image forming apparatus having a peripheral device and/or an integrated user interface device to control and/or set the printing modes in accordance with an exemplary embodiment of the present general inventive concept. As illustrated in FIG. 5, the printing mode may be set through a panel 510 of the image forming apparatus 100, which a user can access. The panel 510 may be a user interface integrated with the image forming apparatus 100 or provided separately. The user interface 510 may generate a signal to control parameters of the printing modes (such as colors, brightness, and the like) of the image forming apparatus 100 and to display printing mode information to the user via a display panel. The user interface 510 may be included in the image forming apparatus 100 as a control unit to control elements of the image forming apparatus and operations of the elements to perform one or more printing modes. It is possible that the parameters of the printing modes can be automatically set in the control unit according to a user command or data to be printed, and the developing devices can scan, develop, and print the images according to the parameters. The printing mode may also be set remotely, for example, using a personal computer (PC) 520, server 530, or another image forming apparatus or an image retrieving apparatus connected via a wired or wireless network 540. For example, a wireless network such as a Bluetooth network or 802.11 standard network may be used to set the printing mode.

As described above, if developing devices containing light cyan and/or light magenta developers are additionally provided to represent light colors which are difficult to represent using yellow, magenta, cyan, and black, the image forming apparatus having the additional developing devices may print an image having high color reproducibility. If the second developing portion 142 having additional colors is disposed opposite the first image forming apparatus 141, the internal space of the image forming apparatus can be used efficiently, and fabrication costs can be reduced as the intermediate transfer belt is made shorter.

The first developing portion 141 can be disposed apart from the second developing portion 142 at a predetermined interval which is a multiple of the interval D1 between the developing devices for yellow, magenta, cyan, and black. The driving mechanism can vary periodically according to the gear ratio of a driving unit, and the driving speed of the belt may not be uniform. Accordingly, each color of the image can be compensated with ease by disposing the developing portions at predetermined intervals.

According to exemplary embodiments of the present general inventive concept, the second developing portion having the developing devices containing light cyan and light magenta can be disposed to be opposite the first developing portion having the developing devices containing yellow, magenta, cyan, and black developers. Therefore, the size of the intermediate transfer belt and image forming apparatus may be reduced.

Since the interval between the first and second developing portion can be set to be a multiple of the interval between the developing devices, it is possible to compensate the color registration sensitive to the interval between the developing devices.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a first developing portion including first to fourth developing devices containing yellow, magenta, cyan, and black developers, respectively, each of the first to fourth developing devices disposed apart from adjacent developing devices of the first to fourth developing devices at a regular interval;
a second developing portion including at least one auxiliary developing device to supplement colors of the first developing portion; and
an image carrier to convey images of the first and second developing portions,
wherein an interval between the first and second developing portions is a multiple of the regular interval between the first to fourth developing devices.

2. The image forming apparatus of claim 1, wherein the multiple is an integer greater than 1.

3. The image forming apparatus of claim 1, wherein the first and second developing portions are disposed on opposite sides of the image carrier.

4. The image forming apparatus of claim 3, wherein the image carrier is a belt rotating in an endless track.

5. The image forming apparatus of claim 3, wherein the image carrier is one of an intermediate transferring unit and a paper feeding and transfer unit.

6. The image forming apparatus of claim 3, further comprising:
a laser scanning unit to form an electrostatic latent image on the first and second developing portions,
wherein the laser scanning unit comprises:
a first laser scanning unit to form an electrostatic latent image on the first developing portion; and
a second laser scanning unit to form an electrostatic latent image on the second developing portion.

7. The image forming apparatus of claim 6, wherein the image carrier comprises:
an intermediate transferring belt;
a first driving roller disposed between the first and second developing portions;
a second driving roller disposed to correspond to a transferring roller to transfer a color image on the printing medium; and
a tension roller disposed between the first and second driving rollers, to adjust the tension of the intermediate transferring belt.

8. The image forming apparatus of claim 7, wherein a speed of the second driving roller is set to be about 0 to 3% faster than a speed of the first driving roller.

9. The image forming apparatus of claim 1, wherein the first developing portion transfers yellow, magenta, cyan, and black developer on a printing image after the second developing portion transfers the printing image to the image carrier.

10. The image forming apparatus of claim 1, wherein the second developing portion comprises:
a first auxiliary developing device to use a light cyan developer; and
a second auxiliary developing device to print a light magenta developer.

11. The image forming apparatus of claim 1, wherein the second developing portion comprises:
an auxiliary developing device to use one of developers having transparent and white colors.

12. The image forming apparatus of claim 1, wherein the second developing portion comprises:
a first auxiliary developing device to use a developer having a light cyan color;
a second auxiliary developing device to use a developer having a light magenta color; and
a third auxiliary developing device to use one of developer having transparent and white colors.

13. An image forming apparatus, comprising:
a first developing portion including first and second developing devices spaced apart at a regular interval; and
a second developing portion including a third developing device disposed closer to the first developing device than the second developing device;
wherein the first and second developing portions convey an image to an image carrier, and if an interval between the first and second developing devices on the image carrier is the regular interval, an interval between the first and third developing devices is a multiple of the regular interval.

14. The image forming apparatus of claim 13, wherein the multiple is an integer greater than 1.

15. The image forming apparatus of claim 13, wherein the color of an image formed by the first to third developing devices differ from each other.

16. The image forming apparatus of claim 15, selectively using:
a first printing mode in which an image is formed using the first developing portion; and
a second printing mode in which an image is formed using both the first and second developing portions.

17. The image forming apparatus of claim 16, wherein the first and second printing modes are selected by a user using the image forming apparatus or a peripheral connected to the image forming apparatus over wire or wirelessly.

18. The image forming apparatus of claim 16, wherein the image carrier is a belt rotating in an endless track.

19. The image forming apparatus of claim 18, wherein the image carrier is one of an intermediate transferring unit or a paper feeding and transfer unit.

20. The image forming apparatus of claim 15, wherein the first and second developing devices of the first developing portion selectively use yellow, magenta, cyan, and black developers, and the third developing device of the second developing portion selectively uses light magenta, light cyan, white, and transparent developers.

21. The image forming apparatus of claim 16, wherein the first and second developing devices of the first developing portion selectively use yellow, magenta, cyan, and black developers, and the third developing device of the second developing portion selectively uses light magenta, light cyan, white, and transparent developers.

22. The image forming apparatus of claim 19, wherein the first and second developing devices of the first developing portion selectively use yellow, magenta, cyan, and black developers, and the third developing device of the second developing portion selectively uses light magenta, light cyan, white, and transparent developers.

23. A developing unit of an image forming apparatus, the developing unit comprising:
a developing portion having a plurality of developing devices disposed at regular intervals along an image carrier to develop images on the image carrier; and
at least one auxiliary developing device spaced apart from the developing portion at an interval different from the regular interval to supplement the images on the image carrier.

24. The developing unit of claim 23, further comprising:
a user interface to selectively control parameters of a first printing mode in which an image is formed using the developing portion and a second printing mode in which an image is formed using both the developing portion and the at least one auxiliary developing device.

25. The developing unit of claim 24, wherein:
the user interface is connected to the image forming apparatus via a wired or wireless network.

26. The developing unit of claim 23, wherein:
the at least one auxiliary developing device is disposed on an image transfer plane opposed to an image transfer plane of the developing portion.

27. The developing unit of claim 23, wherein:
the at least one auxiliary developing device is disposed on an image transfer plane of the developing portion.

28. The developing unit of claim 23, wherein:
the interval is a multiple n of the regular interval, where n is a number greater than or equal to 1.

29. The developing device of claim 28, wherein:
the multiple n is a number less than 1.
